(19) United States
(12) Patent Application Publication
(10) Pub. No.: US 2026/0226850 A1
(43) Pub. Date: Aug. 6, 2026

(54) INCREASED INNER FLOW AREA FAN INLET CASE

(71) Applicant: RTX Corporation, Farmington, CT (US)

(72) Inventors: Ken Blaney, Middleton, NH (US); Anthony R. Bifulco, Ellington, CT (US); Kerrin Elizabeth Mogan Connors, Binghamton, NY (US)

(73) Assignee: RTX Corporation, Farmington, CT (US)

(21) Appl. No.: 19/047,133

(22) Filed: Feb. 6, 2025

(51) Int. Cl. F04D 29/64; F04D 29/056; F04D 29/32

(52) U.S. Cl. CPC F01D 25/162; F01D 25/24

(57) ABSTRACT

An attachment for a fan inlet case and bearing housing including the fan inlet case connected to the bearing housing; an attachment in operative communication with the bearing housing, the attachment being threaded onto threads formed into an outer radial surface of a forward end of the bearing housing; and a locking ring in operative communication with the attachment between the attachment and the fan inlet case, wherein the attachment secures the locking ring and fan inlet case to the bearing housing.

### BACKGROUND

The present disclosure is directed to the improved attachment of a fan inlet case to a bearing housing.

Referring to FIG. 1 and FIG. 2, a gas turbine engine GTE includes a fan inlet case FIC. The gas turbine engine includes an axis A. The fan inlet case FIC can be coupled with a bearing housing BH. A forward variable vane retainer plate VVR can be coupled aft of the fan inlet case FIC. The fan inlet case FIC can be coupled with the bearing housing BH employing several horizontally oriented bolts B. Fan inlet case FIC and forward variable vane retainer VVR are secured to the bearing housing BH using the horizontally orientated bolts B. A nose cone NC can be attached to the fan inlet case FIC with the bolts B.

A radial space RS is required when employing the horizontal bolts B. The radial space RS is considered to be an excess vertical space that is required for the horizontally orientated bolts B. The horizontally bolted assembly drives complexity into the fan inlet case FIC attachment area increasing part cost. The nose cone NC requires doors/ports to access the bolts B. The radial space RS required by the horizontal bolts B takes design space away. The radial space RS required by the horizontal bolts B limits optimization of the engine flow path. The radial space RS required by the horizontal bolts B limits what mechanical systems can be employed to optimize bearing compartment. Processes such as topology optimization require the maximum amount of design space to get the most out of the optimization process and there are a number of bolts, nuts, etc. required to make these connections.

### SUMMARY

In accordance with the present disclosure, there is provided an attachment for a fan inlet case and bearing housing comprising the fan inlet case connected to the bearing housing; an attachment in operative communication with the bearing housing, the attachment being threaded onto threads formed into an outer radial surface of a forward end of the bearing housing; and a locking ring in operative communication with the bearing housing between the attachment and the fan inlet case, wherein the attachment secures the locking ring and fan inlet case to the bearing housing.

A further embodiment of any of the foregoing embodiments may additionally and/or alternatively include the bearing housing comprises a variable vane retainer plate proximate an aft end of the bearing housing, wherein the aft end of the bearing housing is opposite the forward end of the bearing housing.

A further embodiment of any of the foregoing embodiments may additionally and/or alternatively include the attachment for the fan inlet case and the bearing housing further comprising a fan inlet case aft interface in operative communication with a bearing housing load face; a fan inlet case forward interface in operative communication with a locking ring load face.

A further embodiment of any of the foregoing embodiments may additionally and/or alternatively include the fan inlet case aft interface and the bearing housing load face comprise an angled orientation configured to secure the fan inlet case to the bearing housing; and the fan inlet case forward interface and the locking ring load face comprise an angled orientation configured to secure the fan inlet case to the bearing housing.

A further embodiment of any of the foregoing embodiments may additionally and/or alternatively include the attachment for the fan inlet case and the bearing housing further comprising a nose cone attached to the fan inlet case through a threaded connection with the locking ring.

A further embodiment of any of the foregoing embodiments may additionally and/or alternatively include the attachment for the fan inlet case and the bearing housing further comprising at least one locking feature in operative communication with at least one of the locking ring and bearing housing; the attachment and the bearing housing; a nose cone and the locking ring; wherein the at least one locking feature is configured to prevent anti-rotation.

A further embodiment of any of the foregoing embodiments may additionally and/or alternatively include the attachment for the fan inlet case and the bearing housing further comprising a wrenching feature formed on an inner radial surface of the attachment, wherein the wrenching feature is configured to provide leverage for rotation of the attachment.

In accordance with the present disclosure, there is provided a gas turbine engine with an attachment for a fan inlet case and a bearing housing comprising the fan inlet case connected to the bearing housing, the bearing housing comprising an aft end opposite a forward end of the bearing housing; an attachment in operative communication with the bearing housing, the attachment being threaded onto threads formed into an outer radial surface of a forward end of the bearing housing; a locking ring in operative communication with the bearing housing between the attachment and the fan inlet case, wherein the attachment secures the locking ring and fan inlet case to the bearing housing; and a nose cone attached to the fan inlet case through a threaded connection with the locking ring.

A further embodiment of any of the foregoing embodiments may additionally and/or alternatively include the gas turbine engine with an attachment for the fan inlet case and the bearing housing further comprising a fan inlet case aft interface in operative communication with a bearing housing load face proximate the aft end of the bearing housing; and a fan inlet case forward interface in operative communication with a locking ring load face proximate the forward end of the bearing housing.

A further embodiment of any of the foregoing embodiments may additionally and/or alternatively include the fan inlet case aft interface and the bearing housing load face comprise an angled orientation configured to secure the fan inlet case to the bearing housing; and the fan inlet case forward interface and the locking ring load face comprise an angled orientation configured to secure the fan inlet case to the bearing housing.

A further embodiment of any of the foregoing embodiments may additionally and/or alternatively include the gas turbine engine with an attachment for the fan inlet case and the bearing housing further comprising at least one locking feature in operative communication with at least one of the locking ring and bearing housing; the attachment and the bearing housing; the nose cone and the locking ring; wherein the at least one locking feature is configured to prevent anti-rotation.

A further embodiment of any of the foregoing embodiments may additionally and/or alternatively include the gas turbine engine with an attachment for the fan inlet case and the bearing housing further comprising a wrenching feature formed on an inner radial surface of the attachment, wherein the wrenching feature is configured to provide leverage for rotation of the attachment.

A further embodiment of any of the foregoing embodiments may additionally and/or alternatively include the bearing housing comprises an integrally formed forward variable vane retainer plate located aft of the fan inlet case.

In accordance with the present disclosure, there is provided a process of forming a gas turbine engine with an attachment for a fan inlet case and a bearing housing comprising connecting the fan inlet case to the bearing housing, the bearing housing comprising an aft end opposite a forward end of the bearing housing; coupling an attachment in operative communication with the bearing housing, the attachment being threaded onto threads formed into an outer radial surface of a forward end of the bearing housing; coupling a locking ring in operative communication with the bearing housing between the attachment and the fan inlet case; securing the attachment to the locking ring and securing the fan inlet case to the bearing housing; and attaching a nose cone to the fan inlet case through a threaded connection with the locking ring.

A further embodiment of any of the foregoing embodiments may additionally and/or alternatively include the process further comprising coupling a fan inlet case aft interface in operative communication with a bearing housing load face proximate the aft end of the bearing housing; and coupling a fan inlet case forward interface in operative communication with a locking ring load face proximate the forward end of the bearing housing.

A further embodiment of any of the foregoing embodiments may additionally and/or alternatively include the fan inlet case aft interface and the bearing housing load face comprise an angled orientation configured to secure the fan inlet case to the bearing housing; and the fan inlet case forward interface and the locking ring load face comprise an angled orientation configured to secure the fan inlet case to the bearing housing.

A further embodiment of any of the foregoing embodiments may additionally and/or alternatively include the process further comprising coupling at least one locking feature in operative communication with at least one of the locking ring and bearing housing; the attachment and the bearing housing; the nose cone and the locking ring; and configuring the at least one locking feature to prevent anti-rotation.

A further embodiment of any of the foregoing embodiments may additionally and/or alternatively include the process further comprising forming a wrenching feature on an inner radial surface of the attachment; and configuring the wrenching feature to provide leverage for rotation of the attachment.

A further embodiment of any of the foregoing embodiments may additionally and/or alternatively include the bearing housing comprises an integrally formed forward variable vane retainer plate located aft of the fan inlet case.

A further embodiment of any of the foregoing embodiments may additionally and/or alternatively include the attachment comprises a nut load face along an interface between the attachment and the locking ring; configuring the nut load face with an angled orientation to retain the locking ring; and loading the attachment against the locking ring across a circumference of the attachment.

Other details of the attachment for a fan inlet case bearing housing are set forth in the following detailed description and the accompanying drawings wherein like reference numerals depict like elements.

### BRIEF DESCRIPTION OF THE DRAWINGS

The above and further advantages of this disclosure may be better understood by referring to the following description in conjunction with the accompanying drawings, in which like reference numerals indicate like elements and features in the various figures. Letters may be appended to reference numbers to distinguish from reference numbers for similar features and to indicate a correspondence to other features in the drawings. For clarity, not every element may be labeled in every figure. The drawings are not necessarily to scale, emphasis instead being placed upon illustrating the principles of the disclosure.

FIG. 1 is a cross-sectional schematic representation of a prior art gas turbine engine.

FIG. 2 is a cross-sectional a schematic representation of the prior art gas turbine engine.

FIG. 3 is an exploded partial cross sectional view schematic representation of an exemplary gas turbine engine with an exemplary fan inlet case bearing housing attachment.

FIG. 4 is a cross sectional view schematic representation of an exemplary gas turbine engine with an exemplary fan inlet case bearing housing attachment.

FIG. 5 is a schematic representation of is a cross sectional view schematic representation of an exemplary gas turbine engine with an exemplary fan inlet case bearing housing attachment.

FIG. 6 is a cross sectional view schematic representation of an exemplary gas turbine engine with an exemplary fan inlet case bearing housing attachment.

FIG. 7 is a cross sectional view schematic representation of an exemplary gas turbine engine with an exemplary fan inlet case bearing housing attachment.

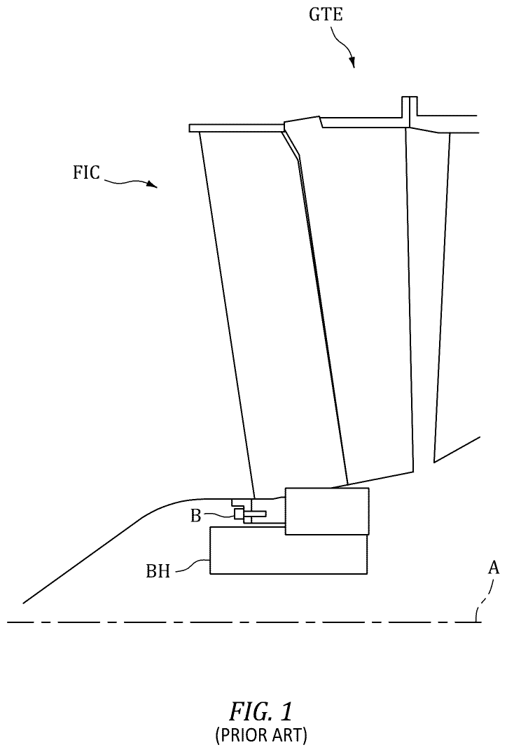

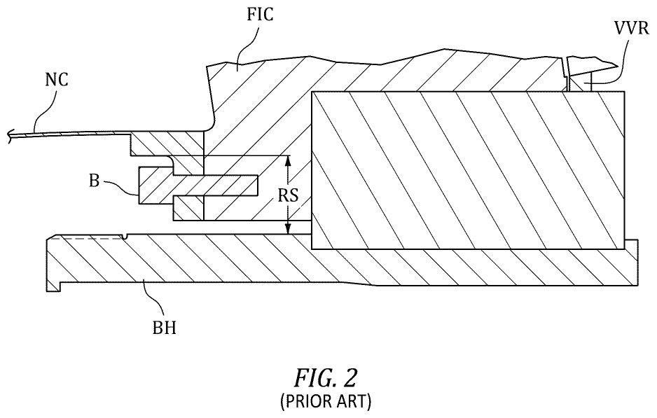

### DETAILED DESCRIPTION

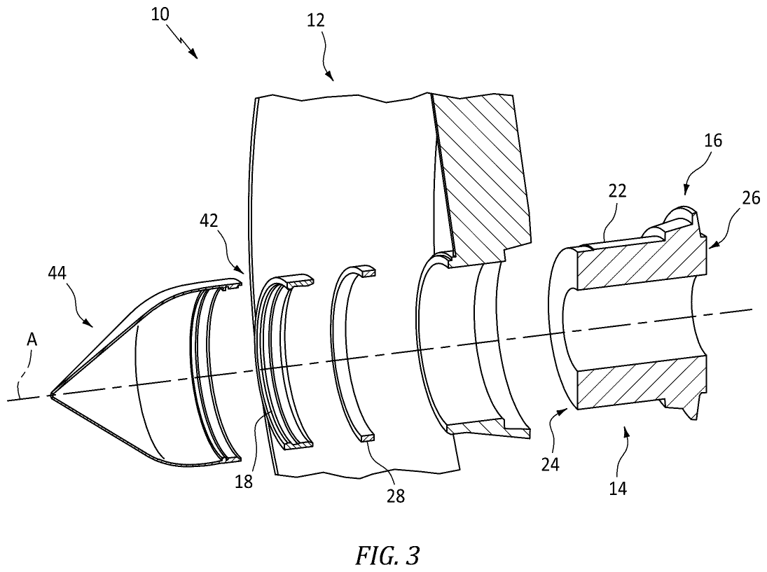

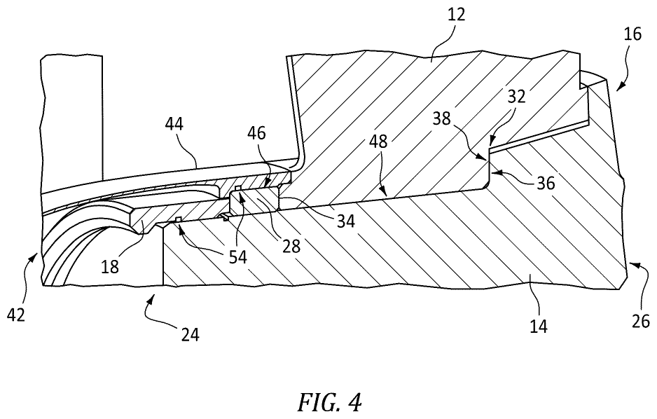

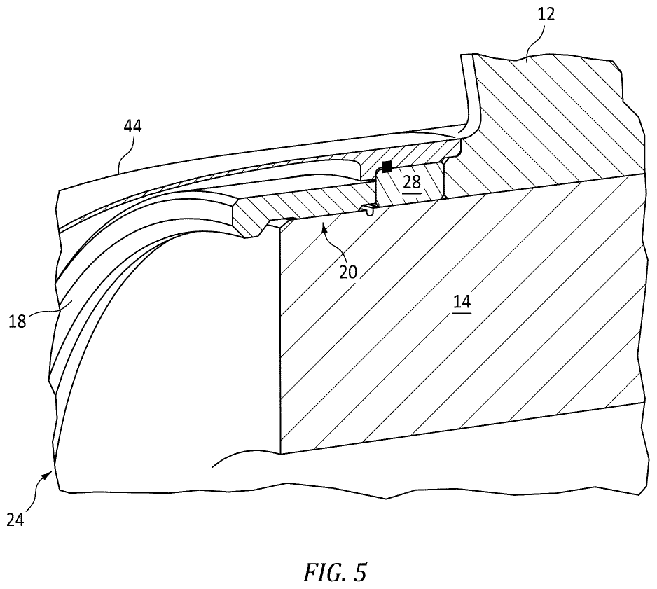

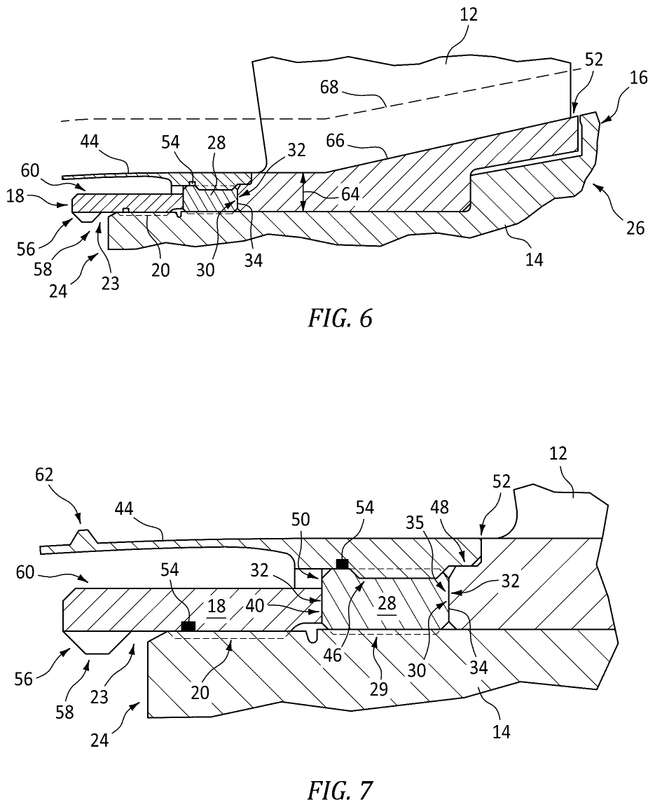

Referring now to FIG. 3, FIG. 4, FIG. 5, FIG. 6 and FIG. 7, showing the exemplary attachment for the fan inlet case bearing housing. The gas turbine engine 10 includes the fan inlet case 12 connected to the bearing housing 14. The bearing housing 14 can include forward variable vane retainer plate 16 located downstream (aft) of the fan inlet case 12. The forward variable vane retainer plate 16 can be separate or formed integrally with the bearing housing 14. Downstream can be understood relative to the airflow direction through the gas turbine engine 10.

The fan inlet case 12 can be coupled with the bearing housing 12 by employing an attachment device or simply attachment 18. The attachment 18 can be configured as a spanner nut threadably attached to the bearing housing 14. The bearing housing 14 can include threads 20 cut into an outer radial surface 22 proximate a bearing housing forward end 24. The attachment 18 can include complimentary threads 20 cut into an inside diameter 23. The retainer plate 16 can be located opposite the attachment 18 at an aft end 26 of the bearing housing 14.

A locking ring 28 can be in operative communication with the bearing housing 14. The locking ring 28 can be anti-rotated to the bearing housing 14 by either a splined arrangement, by using a key and slot, and the like. The locking ring 28 can have a diametrical fit such as a precision fit to the bearing housing 14. The locking ring 28 is configured to transmit the axial force produced by the interaction of the attachment 18 to the bearing housing 14. The locking ring 28 can be threaded by threads 29 attached to the bearing housing 14 between the attachment 18 and the fan inlet case 12. In an exemplary embodiment, the locking ring 28 can be formed integrally from the same material as the fan inlet case 12. The locking ring 28 can include a locking ring load face 30 proximate the interface between the locking ring 28 and the fan inlet case 12, as seen in FIG. 7. The locking ring load face 30 can include a beveled/angled orientation 32 relative to a fan inlet case forward interface 34. The locking ring load face 30 and the fan inlet case forward interface 34 can form a dovetail joint 35 to optimize the retention of the fan inlet case 12 to the bearing housing 14.

The bearing housing 14 can include a bearing housing load face 36. The bearing housing load face 36 can be coupled with a fan inlet case aft interface/axial stop 38 as seen in FIG. 4. The bearing housing load face 36 can include a beveled/angled orientation 32 along with the fan inlet case aft interface/axial stop 38, such as a dovetail, to optimize the retention of the fan inlet case 12 to the bearing housing 14.

The attachment 18 can include a nut load face 40 along the interface between the attachment 18 and the locking ring 28. The nut load face 40 can have a beveled/angled orientation 32 and be configured similar to a dovetail joint in order to retain the locking ring 28. The loading of the attachment 18 against the locking ring 28 spreads across an entire circumference 42 of the attachment 18.

A nose cone 44 can be attached to the fan inlet case 12 through a threaded connection 46 with the locking ring 28. The nose cone 44 and fan inlet case 12 can be interference fit, snap fit 48 together. The nose cone 44 can include a nose cone axial stop 50 that interfaces with the locking ring 28. The fan inlet case 12 and bearing housing 14 can also be snap fit 48 together. A gap 52 can be formed between the nose cone 44 and the fan inlet case 12 as well as between the fan inlet case 12 and the bearing housing 14 proximate the retainer plate 16, see FIG. 6 and FIG. 7.

A locking feature 54 can be employed between the locking ring 28 and bearing housing 14, as well as between the attachment 18 and bearing housing 14. The locking feature 54 can be employed between the nose cone 44 and the locking ring 28. The locking feature 54 can be configured to prevent unwanted rotation, anti-rotation between the components of the gas turbine engine 10, such as the locking ring 28, attachment 18, fan inlet case 12 and nose cone 44. The locking feature 54 can include keys, pins, splines, of various materials such as relatively soft materials like nylon parts. The locking feature 54 can be located at least one axially or radially with respect to the axis A in between the parts mentioned above.

The attachment 18 can include a wrenching feature 56 formed on an inner radial surface 58 of the attachment 18 as seen in FIG. 6 and FIG. 7. The wrenching feature 56 located on the inside diameter 23 of attachment 18 can save space proximate the outside diameter 60 of the attachment 18. The wrenching feature 56 is configured to enable leverage to rotate the attachment 18 on the threads 20. The wrenching feature 56 can be configured as a tab or raised structure.

A spanner wrench feature 62 can be formed in the nose cone 44. The spanner wrench feature can enable tightening the nose cone 44 into proper orientation. The spanner wrench feature 62 can be configured as a male extended feature or as a female indented feature and located distally on the nose cone 44.

The attachment 18 allows for a smaller radial space 64 and thus allows for a larger area for the flow path 66 as compared to the prior flow path 68.

A technical advantage of the disclosed attachment for fan inlet case bearing housing includes significantly increasing the design space in the fan inlet case.

Another technical advantage of the disclosed attachment for fan inlet case bearing housing includes increased flow area into the fan inlet case.

Another technical advantage of the disclosed attachment for fan inlet case bearing housing includes an expanded region of flow path optimization.

Another technical advantage of the disclosed attachment for fan inlet case bearing housing includes bearing compartment optimization.

Another technical advantage of the disclosed attachment for fan inlet case bearing housing includes simplification of the fan inlet case, bearing housing and nose cone reducing cost.

Another technical advantage of the disclosed attachment for fan inlet case bearing housing includes attachment features having full circumferential loading allowing the parts to occupy less radial space.

Another technical advantage of the disclosed attachment for fan inlet case bearing housing includes eliminating the number of smaller fasteners that are currently used for assembly of the fan inlet case, nose cone and locking ring.

There has been provided an attachment for a fan inlet case bearing housing. While the attachment for a fan inlet case bearing housing has been described in the context of specific embodiments thereof, other unforeseen alternatives, modifications, and variations may become apparent to those skilled in the art having read the foregoing description. Accordingly, it is intended to embrace those alternatives, modifications, and variations which fall within the broad scope of the appended claims.

1. An attachment system for a fan inlet case and bearing housing comprising:
the fan inlet case connected to the bearing housing;
an attachment in operative communication with the bearing housing, the attachment being threaded onto threads formed into an outer radial surface of a forward end of the bearing housing; and
a locking ring in operative communication with the bearing housing between the attachment and the fan inlet case, wherein the attachment secures the locking ring and fan inlet case to the bearing housing.

2. The attachment system for the fan inlet case and the bearing housing according to claim 1, wherein the bearing housing comprises a variable vane retainer plate proximate an aft end of the bearing housing, wherein the aft end of the bearing housing is opposite the forward end of the bearing housing.

3. The attachment system for the fan inlet case and the bearing housing according to claim 1, further comprising:
a fan inlet case aft interface in operative communication with a bearing housing load face;
a fan inlet case forward interface in operative communication with a locking ring load face.

4. The attachment system for the fan inlet case and the bearing housing according to claim 3, wherein the fan inlet case aft interface and the bearing housing load face comprise an angled orientation configured to secure the fan inlet case to the bearing housing; and the fan inlet case forward interface and the locking ring load face comprise an angled orientation configured to secure the fan inlet case to the bearing housing.

5. The attachment system for the fan inlet case and the bearing housing according to claim 1, further comprising:
a nose cone attached to the fan inlet case through a threaded connection with the locking ring.

6. The attachment system for the fan inlet case and the bearing housing according to claim 1, further comprising:
at least one locking feature in operative communication with at least one of the locking ring and bearing housing; the attachment and the bearing housing; a nose cone and the locking ring; wherein the at least one locking feature is configured to prevent anti-rotation.

7. The attachment system for the fan inlet case and the bearing housing according to claim 1, further comprising:
a wrenching feature formed on an inner radial surface of the attachment, wherein the wrenching feature is configured to provide leverage for rotation of the attachment.

8. A gas turbine engine with an attachment system for a fan inlet case and a bearing housing comprising:
the fan inlet case connected to the bearing housing, the bearing housing comprising an aft end opposite a forward end of the bearing housing;
an attachment in operative communication with the bearing housing, the attachment being threaded onto threads formed into an outer radial surface of a forward end of the bearing housing;
a locking ring in operative communication with the bearing housing between the attachment and the fan inlet case, wherein the attachment secures the locking ring and fan inlet case to the bearing housing; and
a nose cone attached to the fan inlet case through a threaded connection with the locking ring.

9. The gas turbine engine with an attachment system for the fan inlet case and the bearing housing according to claim 8, further comprising:
a fan inlet case aft interface in operative communication with a bearing housing load face proximate the aft end of the bearing housing; and
a fan inlet case forward interface in operative communication with a locking ring load face proximate the forward end of the bearing housing.

10. The gas turbine engine with an attachment system for the fan inlet case and the bearing housing according to claim 9, wherein the fan inlet case aft interface and the bearing housing load face comprise an angled orientation configured to secure the fan inlet case to the bearing housing; and the fan inlet case forward interface and the locking ring load face comprise an angled orientation configured to secure the fan inlet case to the bearing housing.

11. The gas turbine engine with an attachment system for the fan inlet case and the bearing housing according to claim 8, further comprising:
at least one locking feature in operative communication with at least one of the locking ring and bearing housing; the attachment and the bearing housing;
the nose cone and the locking ring; wherein the at least one locking feature is configured to prevent anti-rotation.

12. The gas turbine engine with an attachment system for the fan inlet case and the bearing housing according to claim 8, further comprising:
a wrenching feature formed on an inner radial surface of the attachment, wherein the wrenching feature is configured to provide leverage for rotation of the attachment.

13. The gas turbine engine with an attachment for the fan inlet case and the bearing housing according to claim 8, wherein the bearing housing comprises an integrally formed forward variable vane retainer plate located aft of the fan inlet case.

14. A process of forming a gas turbine engine with an attachment system for a fan inlet case and a bearing housing comprising:
connecting the fan inlet case to the bearing housing, the bearing housing comprising an aft end opposite a forward end of the bearing housing;
coupling an attachment in operative communication with the bearing housing, the attachment being threaded onto threads formed into an outer radial surface of a forward end of the bearing housing;
coupling a locking ring in operative communication with the bearing housing between the attachment and the fan inlet case;
securing the attachment to the locking ring and securing the fan inlet case to the bearing housing; and
attaching a nose cone to the fan inlet case through a threaded connection with the locking ring.

15. The process of claim 14, further comprising:
coupling a fan inlet case aft interface in operative communication with a bearing housing load face proximate the aft end of the bearing housing; and
coupling a fan inlet case forward interface in operative communication with a locking ring load face proximate the forward end of the bearing housing.

16. The process of claim 14, wherein the fan inlet case aft interface and the bearing housing load face comprise an angled orientation configured to secure the fan inlet case to the bearing housing; and the fan inlet case forward interface and the locking ring load face comprise an angled orientation configured to secure the fan inlet case to the bearing housing.

17. The process of claim 14, further comprising:
coupling at least one locking feature in operative communication with at least one of the locking ring and bearing housing; the attachment and the bearing housing;
the nose cone and the locking ring; and
configuring the at least one locking feature to prevent anti-rotation.

18. The process of claim 14, further comprising:
forming a wrenching feature on an inner radial surface of the attachment; and
configuring the wrenching feature to provide leverage for rotation of the attachment.

19. The process of claim 14, wherein the bearing housing comprises an integrally formed forward variable vane retainer plate located aft of the fan inlet case.

20. The process of claim 14, wherein the attachment comprises a nut load face along an interface between the attachment and the locking ring;
configuring the nut load face with an angled orientation to retain the locking ring; and
loading the attachment against the locking ring across a circumference of the attachment.
